(19) United States
(12) Patent Application Publication
(10) Pub. No.: US 2010/0159415 A1
(43) Pub. Date: Jun. 24, 2010

(54) DENTAL DELIVERY SYSTEM

(76) Inventors: Tom Benfield, York, SC (US); Joe Bria, Waxhaw, NC (US)

Correspondence Address: Beusse Wolter Sanks Mora & Maire, 390 N. ORANGE AVENUE, SUITE 2500, ORLANDO, FL, 32801, US

(21) Appl. No.: 12/624,400

(22) Filed: Nov. 23, 2009

Related U.S. Application Data
(60) Provisional application No. 61/117,205, filed on Nov. 23, 2008.

(51) Int. Cl. A61G 15/14; A61C 19/00

(52) U.S. Cl. 433/79; 433/28

(57) ABSTRACT

Disclosed herein is a dental rear delivery unit for providing an increased range of positioning of a doctor's hand piece delivery head and an assistant's instrument work delivery head at a head end of a dental chair.

### CROSS REFERENCE TO RELATED APPLICATIONS

This application claims priority under 35 USC §119 to U.S. Provisional Patent Application No. 61/117205 filed Nov. 23, 2008. The teachings of this application are incorporated herein in their entirety.

### FIELD OF THE INVENTION

This invention relates to dental delivery units. More particularly this invention relates to a dental delivery unit with dual articulated arms for use at the head-end of a patient dental chair.

### BACKGROUND

Present day dental practice typically incorporates the services of a dentist and at least one other person, often a dental assistant. Both persons must be able to independently but simultaneously perform their tasks in the space surrounding the patient. Typically that space is limited, as it is confined by the surrounding equipment, to a size that limits each person's mobility within that space. For that reason it has been important for the dentist and the dental assistant to be able to access their hand pieces with a minimum amount of movement.

The services performed by both the dentist and the dental assistant often require hand pieces which make use of utilities such as electrical power, compressed air, vacuum, water under pressure, computer and video network cabling, and/or nitrous oxide. As such, these hand pieces need to be physically connected to what is typically a central source of each of these utilities, and often there one central source for each of these utilities per dental operatory room.

Accordingly, various structures known as dental delivery units have been devised to hold the hand pieces where they are needed, while simultaneously serving as a conduit to safely deliver the utilities from the central utility source to the hand pieces. Typically these structures physically converge at the central utility source. This limits the design options, and consequently limits how much freedom the dentist and dental assistant have regarding where they can position their dental hand pieces.

### BRIEF DESCRIPTION OF THE DRAWINGS

The invention is explained in the following description in view of the drawings that show:

FIG. 1 is a perspective view of a dual articulated-arm dental delivery system.

FIG. 2 is an partially exploded perspective view of the sub-systems of the dual articulated-arm dental delivery system of FIG. 1.

FIG. 3 is a top perspective view of doctor delivery flex arm embodiment.

FIG. 4 is a bottom perspective view of an assistant' delivery flex arm embodiment.

FIG. 5 is a view-through side perspective view of a link from a doctor's delivery flex arm embodiment.

FIG. 6 is a view-through side perspective view of a link from an assistant's delivery flex arm embodiment.

FIG. 7 shows a top plan view of a typical dental operatory.

### BRIEF DESCRIPTION OF THE INVENTIVE EMBODIMENTS

The present inventors have innovatively designed a dental delivery system that presents dental assistant hand pieces, organized in a dental assistant instrumentation station, to a dental assistant when the dental assistant is positioned as needed to permit dental procedures on a patient, and further provides a work surface with adjustable positioning.

Among the present inventions is the presentation of dentist hand pieces, in a similarly organized dentist instrumentation station, to a dentist who is also performing dental procedures on the same patient. The present inventions do this while yet providing both the dental assistant and the dentist with the ability to relocate their respective instrumentation station to a wide range of positions, with minimal movement by the person moving the station, and without interfering with the location of the other instrumentation station. Among the present inventions also is keeping the utilities cleanly organized and out of sight throughout the entire utility routing from the dental utility service to the respective dental hand pieces. When used in conjunction with a dental cabinet, the inventions further provide storage, additional working space, and a clean, aesthetically appealing look.

In one embodiment, the inventions pertain to a dental rear delivery unit for providing an increased range of positioning of a doctor's hand piece delivery head and an assistant's instrument work delivery head at a head end of a dental chair. The rear delivery unit includes a doctor delivery flex arm that has a first link mounted at an inner end thereof on a stationary structure for pivotal movement in a generally horizontal plane and a second link mounted at an inner end thereof on the first link at an outer end thereof for pivotal movement in a generally horizontal plane.

The doctor's hand piece delivery head is supported by the second link at an outer end thereof. Further, the doctor flex arm may be articulated for pivotal movement in a vertical plane. Thus, the arrangement of the doctor flex arm provides for adjustment of the vertical and horizontal positions of the doctor delivery head by the doctor when in an operatory work position.

The rear delivery system may further include an assistant delivery flex arm that has a first link mounted at an inner end thereof on a stationary structure for pivotal movement in a generally horizontal plane and a second link mounted at an inner end thereof on the first link at an outer end thereof for pivotal movement in a generally horizontal plane. The assistant instrument delivery head is supported on the second link at an outer end thereof. The assistant flex arm is also articulated for pivotal movement in a vertical plane.

Thus, the arrangement of the assistant delivery flex arm provides for adjustment of the vertical and horizontal position of the assistant instrument delivery head by the assistant when in an assistant operatory work position. The generally horizontal plane for pivoting the inner end of the first link of the assistant flex arm is positioned relative to the generally horizontal plane for pivoting the inner end of the first link of the doctor flex arm, which enables the doctor flex arm to pass the assistant delivery flex arm for selectively reconfiguring the rear delivery unit from a first position enabling the doctor to treat a patient on the dental chair from a first side thereof to a second position enabling the doctor to treat the patient from the other side thereof. This flexibility of the delivery system enables the system to be readily reconfigured to meet the needs of a range different doctors and assistants in terms of their size, their dominant hand usage (i.e., both right and left handed users) and personal operating preferences. This results in a significant increase in productivity of the doctor and assistant providing dental services using the system, as well as greater utility for the system by accommodating a wide range of dentists and assistants as may be using the system on different days and work shifts.

In a related embodiment, the doctor delivery head is mounted on the doctor delivery flex arm for pivotal movement in a generally horizontal plane for enabling the doctor delivery head to be positioned for use by the doctor anywhere between a position adjacent the left shoulder of the patient to a position adjacent the right shoulder of the patient. Moreover, the assistant delivery head is mounted on the assistant delivery flex arm for pivotal movement in a generally horizontal plane for enabling the assistant delivery head to be positioned for use by the assistant anywhere between a position adjacent the left shoulder of the patient to the right shoulder of the patient.

Further, the generally horizontal plane of the inner end of the first link of the assistant delivery flex arm may be positioned above the generally horizontal plane of the inner end of the first link of the doctor delivery flex arm to enable the assistant delivery head flex arm to pass over the doctor delivery flex arm. The first link of the doctor delivery flex arm pivots around a vertical axis and the first link of the assistant delivery flex arm pivots around a vertical axis, with the axes being substantially co-axial.

The assistant flex arm may further include a third arm supported by the second arm and mounted for pivotal movement in a generally horizontal plane, and a fourth arm pivotally supported by the third arm and mounted for pivotal movement in a generally horizontal plane. The assistant instrument delivery head in this embodiment is pivotally mounted on the fourth arm. According to another embodiment, the assistant flex arm may further include a dental work surface member carried on the assistant flex arm.

The assistant flex arm may also include a brake and release mechanism for enabling manual positioning of the vertical position of the assistant work surface member carried on the assistant flex arm and holding the assistant work surface member in a desired vertical position. A switch may be provided for controlling the operation of the brake and release mechanism, with the switch being carried on the assistant work surface member. In a more specific embodiment, the switch does not project outwardly relative to the adjacent surfaces of the assistant work surface member.

In another related embodiment, the doctor headpiece delivery head provides support for hand pieces and operator interfaces for the operation of the hand pieces, but is substantially free of infrastructure for providing utilities to the hand pieces for enabling reduced delivery head size. The embodiment may further include a brake and release mechanism for enabling manual positioning of the vertical position of the doctor's hand piece delivery head carried on the doctor delivery flex arm and holding the doctor's hand piece delivery head in a desired vertical position. In addition, the embodiment may include a brake and release mechanism for enabling manual positioning of the vertical position of the assistant delivery head carried on the assistant flex arm and holding the assistant delivery head in a desired vertical position the embodiment, the embodiment may further include a switch controlling the operation of the brake and release mechanism, with the switch being carried on the assistant delivery head. In a specific embodiment, the switch does not project outwardly relative to the adjacent surfaces of the assistant delivery head.

### DETAILED DESCRIPTION OF THE DRAWINGS

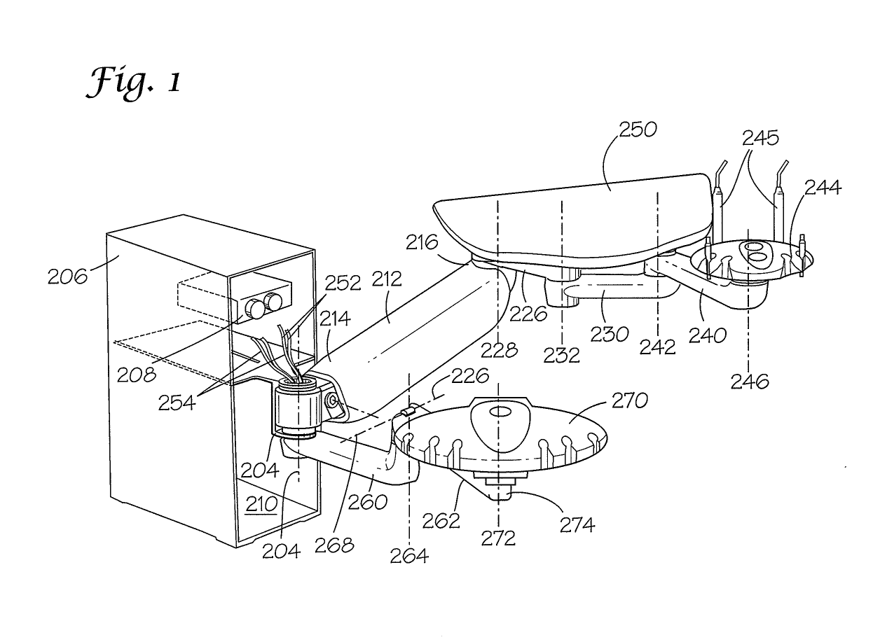

Turning to the drawings, FIG. 1 shows an assembled dental delivery system 200 which includes a dental delivery assembly base 204 with a dental delivery system base vertical axis 202, dental utility system housing 206, a dental utility system platform assembly 208, and an open front 210.

Also shown are a dental assistant flex arm 211, having a first link 212, with an inner end 214, and an outer end 216, dental assistant main arm pivot mechanism 218 (not shown) enabling the dental assistant flex arm to move in a horizontal axis 222, a second link 226, a second link vertical axis 228, a third link 230, a third link vertical axis 232, a fourth link 240, and a fourth link vertical axis 242 about which the fourth link can pivot. The dental assistant flex arm further includes a dental assistant delivery head 244, dental assistant delivery head vertical axis 246 about which the delivery head can pivot, dental assistant hand pieces 248 on the head, and assistant work surface member 250. Also shown are dental assistant utility cables and conduits 252, and dentist utility cables and conduits 254.

In an embodiment, first link inner end 214 is associated with a knuckle that engages dental delivery assembly base 204 such that first link arm 212 is free to pivot horizontally about dental delivery system base vertical axis 202. The first link inner end end 214 need be associated with a knuckle, however, but may be associated with any joint suitable to provide support and allow pivoting in a horizontal plane. The first link 212 also includes a dental assistant main arm pivot mechanism 218, which in an embodiment is a dual arm, dual pivot mechanism that allows the height of first line outer end 216 to be vertically adjusted respective to the first link horizontal axis 222 while keeping the first link outer end 216 in the same orientation, regardless of its vertical positioning. The second link 226 is pivotably connected to the first link outer end 216, and the connection pivots in a horizontal plane about the second link vertical axis 228. Suitable joint mechanisms are known to those of ordinary skill in the art. The second link 226 is similarly pivotably connected to the third link 230, and the connection pivots in a horizontal plane about the third link vertical axis 232. The third link 230 is similarly connected to the fourth link 240, and the connection pivots in a horizontal plane about the fourth link vertical axis 242. The fourth link 240 is pivotably connected to dental assistant delivery head 244, and the connection pivots in a horizontal plane about the assistant delivery head vertical axis 246. Dental assistant work surface member 250 may be attached to any of second 226, third 230, or fourth 240 links, such that it does not interfere with the movement of any of the links. Dental assistant work surface member 250 is shown as being attached to the second link 226. Finally, dental assistant utility cables and conduits 252 are routed from the dental utility system platform assembly 208, through a dental assistant utilities channel (not shown) in each of the links of the assistant flex arm 211 to provide utilities to the dental assistant hand pieces 248. It can be seen that dental assistant work surface member 250 remains in a horizontal orientation because the second link 226 remains in a horizontal orientation when it is adjusted vertically. Similarly, the dental assistant delivery head 244 maintains its horizontal orientation while it retains three degrees of freedom to move, and also rotate about fourth link vertical axis 246.

Also shown in FIG. 1 are the doctor delivery flex arm 259 having a first link 260, a second link 262, a second link vertical axis 264, a doctor arm pivot mechanism 266, a second link horizontal axis 268, a second link outer end 274, a doctor's hand piece delivery head 270, and vertical axis 272.

In an embodiment, the doctor delivery first link 260 also pivotably connects to the dental delivery assembly base 204 such that the first link 260 is free to pivot horizontally about dental delivery system base vertical axis 202, without interfering with the motion of the assistant delivery flex arm 212. The first link 260 at an outer end thereof is pivotably connected to the second link 262 at an inner end thereof, and the connection pivots in a horizontal plane about the second link vertical axis 264. The second link 262 also includes a doctor delivery flex arm pivot mechanism 266, which in an embodiment is a dual arm, dual pivot mechanism that allows the height of the second link outer end 274 to be adjusted respective to the second link horizontal axis 268 without rotating second link outer end 274, thus keeping the second link outer end 274 in the same orientation, regardless of its vertical positioning. Doctor delivery flex arm pivot mechanism 266 may be any sort of pivot mechanism that permits adjustment of second link outer end 274 without imparting rotation to the second link outer end 274. The second link 262 is pivotably connected to the doctor's hand piece delivery head 270, and the connection pivots in a horizontal plane about vertical axis 272. Finally, dentist utility cables and conduits 254 are routed from the dental utility system platform assembly 208, through the doctor delivery flex arm, to the dentist hand pieces 274. It can be seen that the doctor's hand piece delivery head 270 retains its horizontal orientation while it retains three degrees of freedom to move, and also rotate about vertical axis 272.

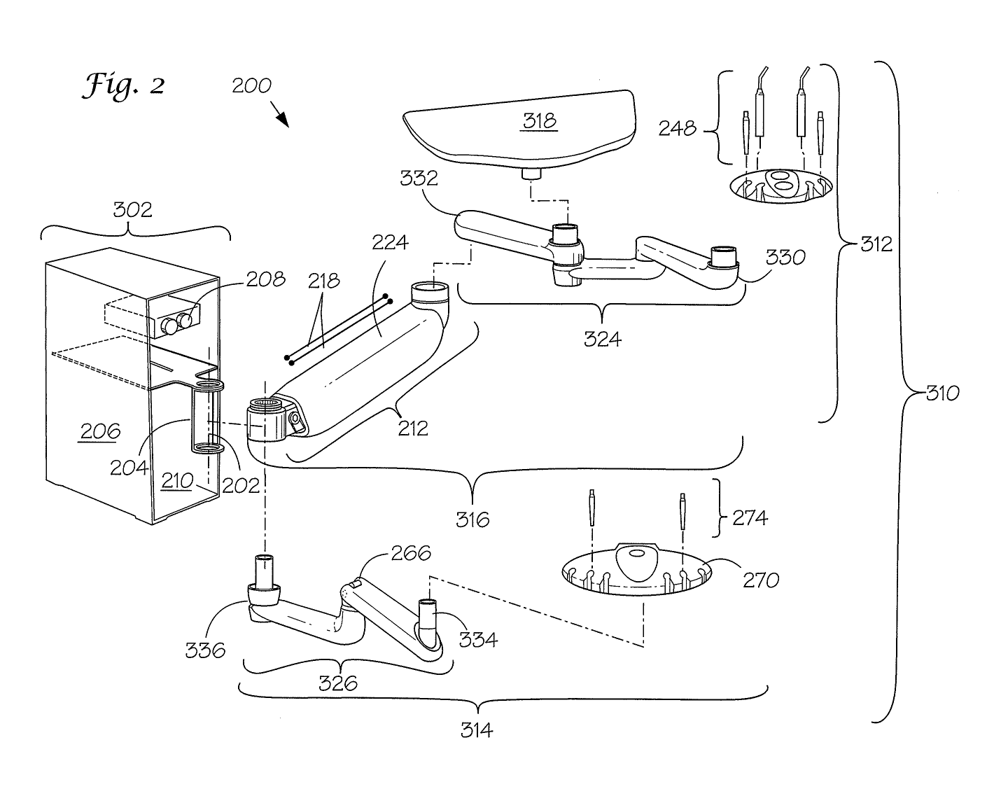

FIG. 2 shows the dental delivery system 200 of FIG. 1 in a partially exploded view and is included for clarity, to define and show the multiple systems and assemblies that make up the dental delivery system. The dental utility system 302 of this embodiment comprises the dental utility system housing 206, the dental utility system platform assembly 208, and a dental delivery assembly base 204. The dental delivery assembly base 204 is connected to the dental utility system housing 206 and serves to connect the dental delivery assembly 310 to the dental utility system housing 206.

The dental delivery assembly 310 includes a dental assistant instrumentation delivery assembly 312, and a dentist instrumentation delivery assembly 314. The dental assistant delivery assembly 312 is composed of a dental assistant flex arm assembly 316, a dental assistant work surface member 318, and a dental assistant delivery head. The dental assistant flex arm assembly 316 is further composed of a first link 212, which is further composed of a dental assistant main arm pivot mechanism 218, and a dental assistant arm sub-assembly 324 further comprising a dental assistant arm sub-assembly inner end 332 and a dental assistant arm sub-assembly outer end 330. The dental assistant arm sub-assembly 324 is further composed of the second, third and fourth links.

The doctor delivery flex arm assembly 314 is composed of a doctor delivery flex arm first assembly 326 further comprising an inner end 336, an outer end 334, a doctor's hand piece delivery head 270, and doctor's hand pieces 274. The doctor delivery flex arm assembly 326 is further composed of the first link 260 and the second link 262, and a doctor delivery flex arm pivot mechanism 266.

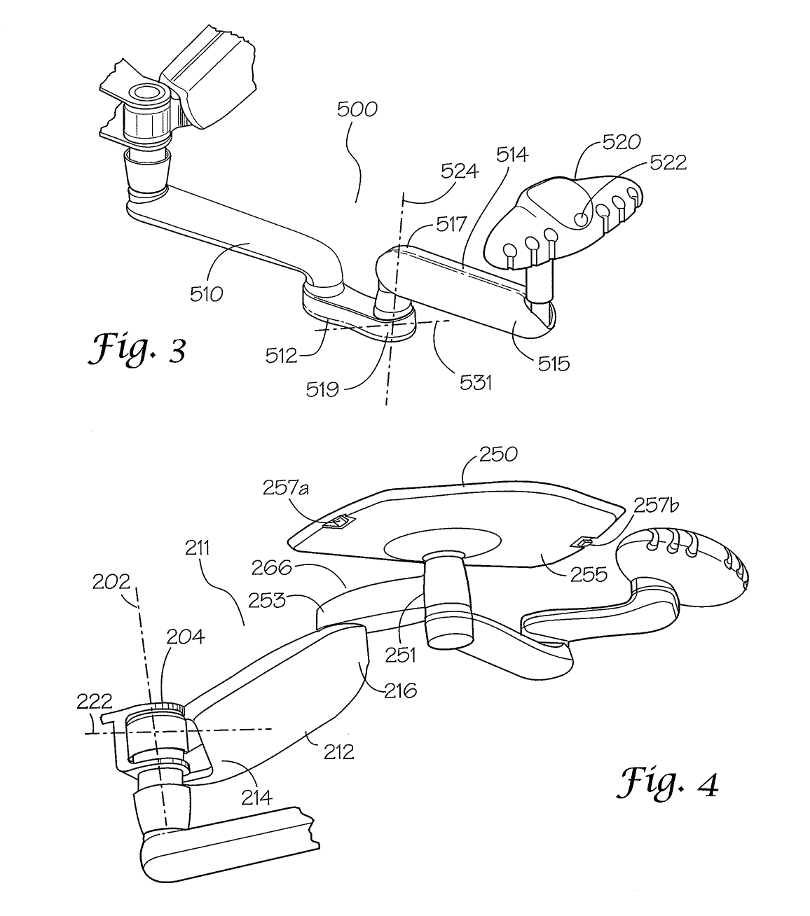

FIG. 3 shows a top perspective view of a doctor delivery flex arm embodiment 500 that comprises a first link 510, and intermediate link 512 and a second link 514. Mounted on the outer end 515 of the second link 514 is a doctor hand piece delivery head 520. At the inner end 517 of the second link 514, the second link is mounted on the outer end 519 of the intermediate link 512. The second link 514 is mounted on the intermediate link so as to be horizontally pivotable about axis 529 and/or vertically pivotable about axis 531. Provided in the second link is a brake and release mechanism (not shown) that interacts with the internal arm components (not shown) such that the brake and release mechanism locks the second link with respect to its vertical pivoting and/or horizontal pivoting. Typically, the brake and release locks the vertical pivoting motion. The doctor hand piece delivery head 520 includes an actuator 522 for controlling the brake and release function in the second link 514. The actuator 522 is configured so as to not outwardly project from the doctor hand piece delivery head 520. In one embodiment, the brake and release mechanism involves a solenoid valve that is actuated by contact with the actuator 522.

FIG. 4 shows a bottom perspective view of an assistant's delivery flex arm 211. The arm 211 includes a first link 212, a second link 266, and an assistant's work surface member 250. The work surface member 250 is mounted on the outer end 251 of the second link 266, and at the inner end 253 of the second link 266, the second link 266 is mounted to the outer end 216 of the first link. At an inner end 214, the first link 212 is mounted to a base 204 so as to be horizontally pivotable about axis 202 and vertically pivotable about axis 222. The flex arm 211 includes a brake and release mechanism contained within the first link 212. Disposed on the bottom surface 255 of the work surface member 250 is a first and second actuator 257a and 257b. One of the first and second actuators 257a, b, actuates the brake function and the other actuates the release function, or vice versa, or either actuator performs both functions. As shown in FIG. 4, the actuators 257a, b do not project outwardly from the adjacent surface 255.

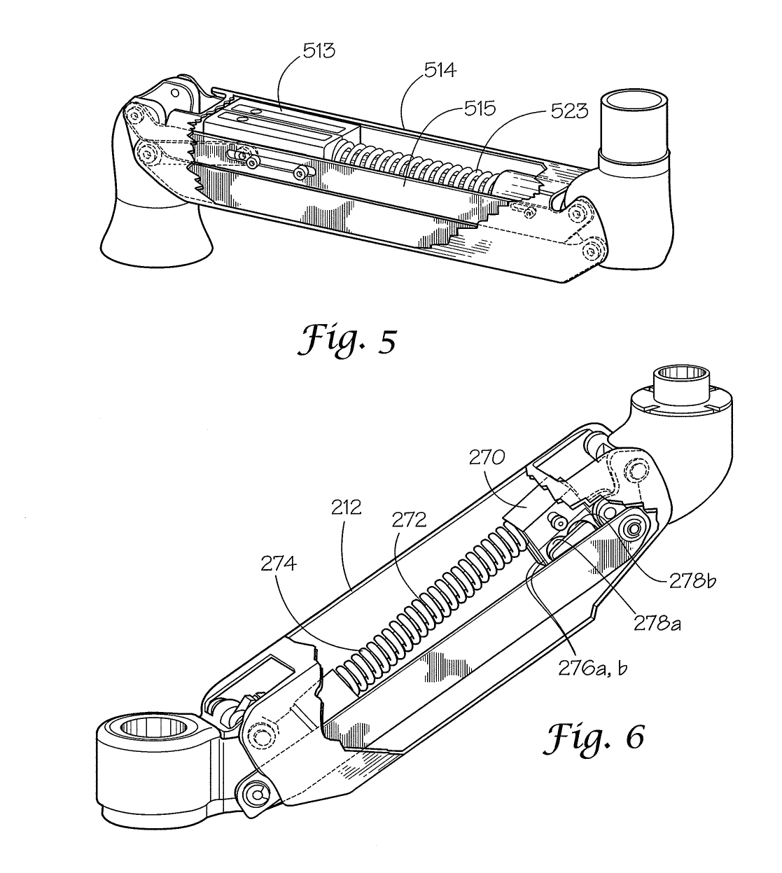

FIG. 5 shows a view-through side perspective view of link 514 containing brake and release mechanism 513 that interacts with rod 515 which is shown disposed within a spring component 523. Upon actuation of the actuator 522 (see FIG. 3), the brake and release mechanism 513 imparts pressure onto rod 515 which prevents rod 515 from sliding respective to brake 513 thereby locking link 514 at desired position. In one embodiment the brake and release mechanism 513 is controlled pneumatically, whereby depressing the actuator 522 activates a solenoid (not shown) which then delivers air to a lever (not shown) in the brake 513, or some other alternative structure, which urges the lever against rod 515.

FIG. 6 shows a view-through side perspective view of link 212 thereby revealing brake and release mechanism 270. The link 212 includes a rod 272 surrounded by a spring component 274. The brake mechanism shown is configured as a u-plate having two arms 276a-b that hug rod 272. The disposed on the brake 270 are two pistons 278a, b. Upon actuation of first or second actuators 257a,b, a solenoid (not shown) delivers air to the pistons 278a,b which urges the arms 276a,b to grasp the rod 272, thereby preventing movement of the rod 272 through the brake 270. This in turn locks the link 212 in the desired position.

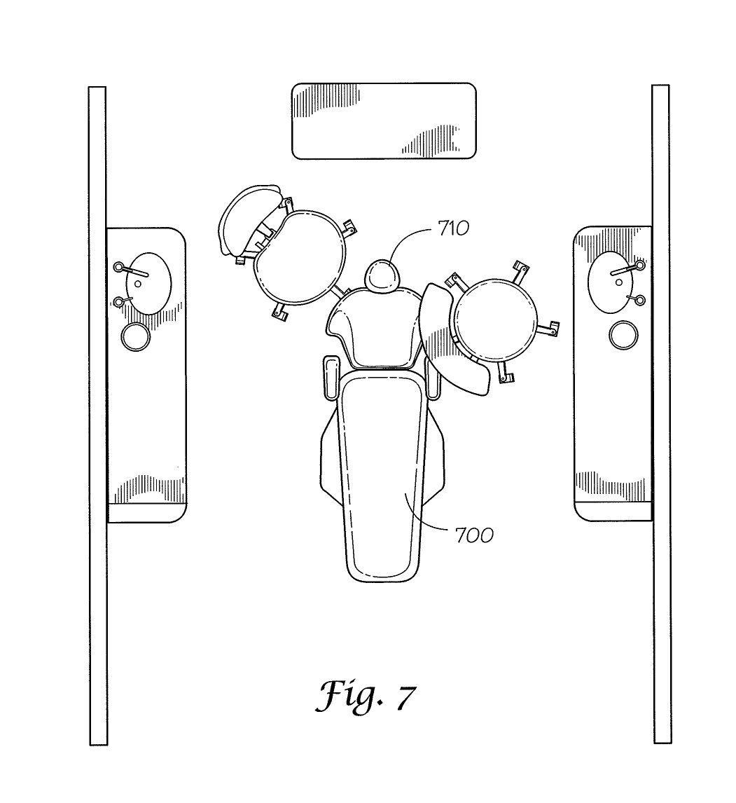

Reference is made herein to a head end of a dental chair. FIG. 7 shows a top plan view of a typical dental operatory. FIG. 7 shows an example of a dental chair 700 having a head end 710.

Thus, the inventors of the present dental delivery system have invented a flexible dental delivery system that can be used by itself, or in conjunction with a dental utility system and/or in conjunction with a dental cabinet or associated with some other stationary structure such as, but not limited to a ceiling or wall, to deliver dental hand pieces to a dental assistant and a dentist who are simultaneously working on a single patient. The dental delivery system permits each person to position their respective hand pieces in a wide range of locations without requiring that person to move, and without interfering with the position of the other person's hand pieces. The dental delivery system further conceals the utilities required for the dental hand pieces, and when used in conjunction with a dental cabinet, can provide storage and additional workspace in a location near the dental delivery system.

While the pivotal connection of the doctor delivery flex arm 259 to the housing 206 and the pivotal connection of the dental assistant flex arm 211 are shown as being on a common vertical axis, with the dental assistant flex arm pivot positioned above the dentist flex arm pivot, other arrangements are also within the scope of these inventions. More particularly, the pivotal connection for the dentist flex arm may be positioned above that for the dental assistant. Also, these pivotal connections need not be coaxial, but may be laterally offset from each other. And either one or both of the pivotal connections may be mounted on a horizontally movable support member on the housing 206 so that the respective flex arm can be moved laterally with respect to the housing and thus the patient dental chair.

While various embodiments of the present inventions have been shown and described herein, it will be obvious that such embodiments are provided by way of example only. Numerous variations, changes and substitutions may be made without departing from the inventions herein. Accordingly, it is intended that the inventions be limited only by the spirit and scope of the appended claims.

The invention claimed is: //

1. A dental rear delivery unit for providing an increased range of positioning of a doctor's hand piece delivery head and an assistant's instrument work delivery head at a head end of a dental chair, the rear delivery unit comprising:
a doctor delivery flex arm comprising a first link mounted at an inner end thereof on a stationary structure for pivotal movement in a generally horizontal plane, a second link mounted at an inner end thereof on the first link at an outer end thereof for pivotal movement in a generally horizontal plane, the doctor's hand piece delivery head, with head being supported by the second link at an outer end thereof, and with the doctor flex arm further being articulated for pivotal movement in a vertical plane to provide for adjustment of the vertical and horizontal positions of the doctor delivery head by the doctor when in an operatory work position;
an assistant delivery flex arm comprising a first link mounted at an inner end thereof on a stationary structure for pivotal movement in a generally horizontal plane, a second link mounted at an inner end thereof on the first link at an outer end thereof for pivotal movement in a generally horizontal plane, the assistant instrument delivery head being supported on the second link at an outer end thereof, and with the assistant flex arm further being articulated for pivotal movement in 11556-019 position of the assistant instrument delivery head by the assistant when in an assistant operatory work position; and
with the generally horizontal plane for pivoting the inner end of the first link of the assistant flex arm being positioned relative to the generally horizontal plane for pivoting the inner end of the first link of the doctor flex arm for enabling the doctor flex arm to pass the assistant delivery flex arm for selectively reconfiguring the rear delivery unit from a first position enabling the doctor to treat a patient on the dental chair from a first side thereof to a second position enabling the doctor to treat the patient from the other side thereof for increased productivity of the doctor and assistant providing dental services.

2. The dental rear delivery unit of claim 1 wherein the doctor delivery head is mounted on the doctor delivery flex arm for pivotal movement in a generally horizontal plane for enabling the doctor delivery head to be positioned for use by the doctor anywhere between a position adjacent the left shoulder of the patient to a position adjacent the right shoulder of the patient.

3. The dental rear delivery unit of claim 1 wherein the assistant delivery head is mounted on the assistant delivery flex arm for pivotal movement in a generally horizontal plane for enabling the assistant delivery head to be positioned for use by the assistant anywhere between a position adjacent the left shoulder of the patient to the right shoulder of the patient.

4. The dental rear delivery unit of claim 1 wherein the generally horizontal plane of the inner end of the first link of the assistant delivery flex arm is positioned above the generally horizontal plane of the inner end of the first link of the doctor delivery flex arm to enable the assistant delivery head flex arm to pass over the doctor delivery flex arm.

5. The dental rear delivery unit of claim 1 wherein the first link of the doctor delivery flex arm pivots around a vertical axis and the first link of the assistant delivery flex arm pivots around a vertical axis, with the axes being substantially co-axial.

6. The dental rear delivery unit of claim 1 wherein the assistant flex arm further comprises a third link supported by the second link and mounted for pivotal movement 11556-019 in a generally horizontal plane, a fourth link pivotally supported by the third link and mounted for pivotal movement in a generally horizontal plane, with the assistant instrument delivery head being pivotally mounted on the fourth link.

7. The dental rear delivery unit of claim 6 wherein the assistant flex arm further comprises a dental work surface member carried on the assistant flex arm.

8. The dental rear delivery unit of claim 6 further comprising a brake and release mechanism for enabling manual positioning of the vertical position of the assistant work surface member carried on the assistant flex arm and holding the assistant work surface member in a desired vertical position.

9. The dental rear delivery unit of claim 8 further comprising a switch controlling the operation of the brake and release mechanism, with the switch being carried on the assistant work surface member.

10. The dental rear delivery unit of claim 9 wherein the switch does not project outwardly relative to the adjacent surfaces of the assistant work surface member.

11. The dental rear delivery unit of claim 1 wherein the doctor headpiece delivery head provides support for hand pieces and operator interfaces for the operation of the hand pieces, but is substantially free of infrastructure for providing utilities to the hand pieces for enabling reduced delivery head size.

12. The dental rear delivery unit of claim 2 further comprising a brake and release mechanism for enabling manual positioning of the vertical position of the doctor's hand piece delivery head carried on the doctor delivery flex arm and holding the doctor's hand piece delivery head in a desired vertical position.

13. The dental rear delivery unit of claim 1 further comprising a brake and release mechanism for enabling manual positioning of the vertical position of the assistant delivery head carried on the assistant flex arm and holding the assistant delivery head in a desired vertical position. 11556-019

14. The dental rear delivery unit of claim 13 further comprising a switch controlling the operation of the brake and release mechanism, with the switch being carried on the assistant delivery head.

15. The dental rear delivery unit of claim 14 wherein the switch does not project outwardly relative to the adjacent surfaces of the assistant delivery head.
